(19) United States
(12) Patent Application Publication
(10) Pub. No.: US 2011/0304212 A1
(43) Pub. Date: Dec. 15, 2011

(54) RENEWABLE ENERGY STORAGE SYSTEM

(75) Inventors: Jongki Choi, Yongin-si (KR); Sungsoo Hong, Yongin-si (KR); Chungwook Roh, Yongin-si (KR); Sangkyoo Han, Yongin-si (KR)

(73) Assignee: Samsung SDI Co., Ltd., Yongin-si (KR)

(21) Appl. No.: 13/004,784

(22) Filed: Jan. 11, 2011

(30) Foreign Application Priority Data
Jun. 14, 2010 (KR) 10-2010-0055999

(51) Int. Cl. H02M 7/757; H02J 9/06

(52) U.S. Cl. 307/66; 363/132

(57) ABSTRACT

A bidirectional inverter of a renewable energy storage system is disclosed. In one embodiment, the bidirectional inverter includes a switching unit including a first switch connected to the DC link in series and a second switch connected to the DC link in parallel, an inductor electrically connected to the switching unit, a full-bridge switching unit electrically connected to the inductor, and a controller electrically connected to the switching unit, and the full-bridge switching unit.

### CROSS-REFERENCE TO RELATED APPLICATIONS

This application claims the benefit of Korean Patent Application No. 10-2010-0055999 filed on Jun. 14, 2010, the contents of which are incorporated herein by reference in their entirety.

### BACKGROUND

1. Field

The disclosed technology relates to a bidirectional inverter of a renewable energy storage system.

2. Description of the Related Technology

In general, a renewable energy storage system, such as a solar cell based system or a wind power generator based system, includes a number of converters and inverters for storing energy generated with various voltages of alternating current (AC) or direct current (DC) power. The renewable energy storage system uses a DC-to-AC inverter to convert DC power generated by a solar cell to AC power that is provided to an electric power system. Further, since the power generated by a solar cell has a different voltage level than that of a battery, a DC-to-DC converter is used to change the power generated by the solar cell to the power having a voltage level suitable for the battery.

Electric power systems, such as power companies, produce power from various resources which have varying degrees of reliability. For instance, renewable energy resources are naturally replenished but flow-limited. They are virtually inexhaustible in duration but limited in the amount of energy that is available per unit time.

Furthermore, to supply electric power to consumers, the power generators must distribute their energy to a power grid. An electric power grid is a system of synchronized power providers and consumers connected by transmission and distribution lines and operated by one or more control centers. Thus, the reliability of adequate power for distribution depends on both the availability generated and the proper flow through the grid.

A breakdown in either power provider or grid can cause a complete or partial power outage. In addition, there may be a transition period, sometimes called a quasi-normal state, that occurs between such abnormal and normal states of power distribution. In these instances of disruption, a battery back up for the load i.e. a device that uses electric power, on the consumer side may be used to maintain effective reliability to the electric power user.

### SUMMARY OF CERTAIN INVENTIVE ASPECTS

One inventive aspect is a bidirectional inverter of a renewable energy storage system configured to transmit power from a direct current (DC) link to an electric power system or to transmit power from the electric power system to the DC link. The bidirectional inverter includes a switching unit with a first switch connected to the DC link in series and a second switch connected to the DC link in parallel, an inductor electrically connected to the switching unit, a full-bridge switching unit electrically connected to the inductor, and a controller electrically connected to the switching unit and the full-bridge switching unit.

Another inventive aspect is a renewable energy storage system connected to an electric power system. The energy storage system includes a battery, and a bidirectional inverter configured to conditionally transmit power from a DC link to an electric power system and to conditionally transmit power from the electric power system to the DC link. The bidirectional inverter includes a switching unit with a first switch connected to the DC link in series and a second switch connected to the DC link in parallel, an inductor electrically connected to the switching unit, a full-bridge switching unit electrically connected to the inductor, and a controller electrically connected to the switching unit and the full-bridge switching unit.

### BRIEF DESCRIPTION OF THE DRAWINGS

FIG. 1 is a schematic block diagram of a renewable energy storage system according to an embodiment;

FIG. 2 is a schematic diagram of a bidirectional inverter of a renewable energy storage system according to an embodiment;

FIG. 3A is a schematic diagram illustrating a mode 0 path when the bidirectional inverter of FIG. 2 operates in an inverter mode;

FIG. 3B is a schematic diagram illustrating a mode 1 path when the bidirectional inverter of FIG. 2 operates in an inverter mode;

FIG. 4A is a schematic diagram illustrating a mode 0 path when the bidirectional inverter of FIG. 2 operates in a PFC (Power Factor Correction) mode;

FIG. 4B is a schematic diagram illustrating a mode 1 path when the bidirectional inverter of FIG. 2 operates in a PFC mode;

FIG. 5A is a schematic diagram illustrating the bidirectional inverter of FIG. 2 operating in an inverter mode;

FIG. 5B is a schematic diagram illustrating an algorithm of a controller in the bidirectional inverter of FIG. 2 according to an embodiment operating in an inverter mode;

FIG. 5C is a graph illustrating waveforms of the bidirectional inverter according to an embodiment operating in an inverter mode;

FIG. 6A is a block diagram of the bidirectional inverter according to an embodiment operating in a PFC mode;

FIG. 6B is a block diagram illustrating an algorithm of a controller in the bidirectional inverter according to an embodiment operating in a PFC mode; and

FIG. 6C is a graph illustrating waveforms of the bidirectional inverter according to an embodiment operating in a PFC mode.

### DETAILED DESCRIPTION OF CERTAIN INVENTIVE EMBODIMENTS

Example embodiments are described more fully hereinafter with reference to the accompanying drawings. However, the various aspects and principles may be embodied in different forms and should not be construed as limited to the embodiments set forth herein. Rather, these embodiments are provided so that this disclosure will be thorough and complete, and will convey the disclosed aspects and principles to those skilled in the art.

Throughout the specification, like numerals generally refer to like elements.

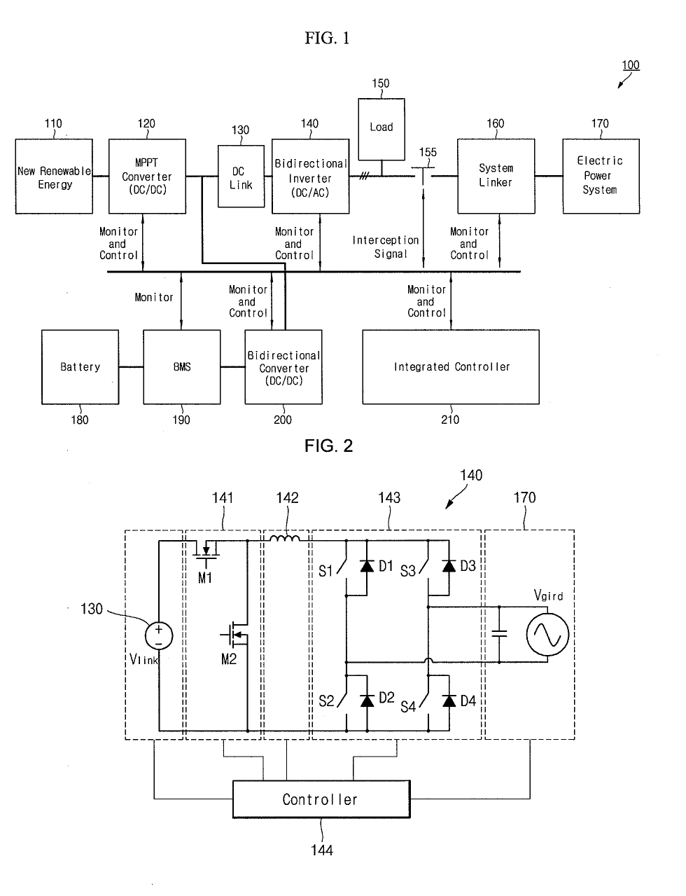

FIG. 1 is a schematic block diagram of a renewable energy storage system according to an embodiment. As shown in FIG. 1, the renewable energy storage system 100 includes a renewable energy generator 110, a maximum power point tracking (MPPT) converter 120, a direct current (DC) link 130, a bidirectional inverter 140, a load 150, a system linker 160, an electric power system 170, a battery 180, a battery monitoring system (BMS) 190, a bidirectional converter 200, and an integrated controller 210.

The renewable energy generator 110 comprises a power generation system which generates power from a renewable source such as, without limitation, sunlight, wind, water, and geothermal heat. More specifically, the renewable energy generator 110 may produce electrical power with, for example, a photovoltaic (PV) generator, a wind power generator, or equivalents thereof. In the following, the renewable energy generator 110 is described with regard to a solar cell as an example.

The MPPT converter 120 extracts the maximum power from the renewable energy generator 110 and converts the power to a different voltage of an output DC power. The output of the solar cell varies nonlinearly with the amount of solar radiation and surface temperature, which is the main cause of degradation in power generation efficiency of the solar cell. The MPPT converter 120 causes the solar to cell operate at a maximum power point. The maximum power point of the solar cell varies nonlinearly with respect to the amount of solar radiation and surface temperature. The power extracted at the maximum power point is converted to a different voltage of DC power and is provided to the DC link 130.

The DC link 130 temporarily stores a DC voltage supplied from the MPPT converter 120. The DC link 130 may be a high capacity capacitor or another suitable device. Thus, the DC link 130 removes an alternating current (AC) component from the DC power output from the MPPT converter 120 and stores stable DC power. The DC link 130 also stabilizes and temporarily stores a DC voltage supplied from the bidirectional inverter 140 or the bidirectional converter 200, which will be described in detail later.

The bidirectional inverter 140 converts the DC power provided by the DC link 130 into AC power (e.g., commercial AC power) and outputs the AC power. For example, the bidirectional inverter 140 may convert a DC voltage from the renewable energy generator 110 or the battery 180 into AC power that is suitable for home use. The bidirectional inverter 140 also converts AC power (e.g., commercial AC power) provided by the electric power system 170 into DC power and feeds the DC power into the DC link 130. The power stored in the DC link 130 may be provided to the battery 180 through the bidirectional converter 200.

The load 150 may be a home or industrial facility using AC voltage (e.g., commercial AC voltage). The load 150 receives AC power from any of the renewable energy generator 110, the battery 180, and the electric power system 170.

The system linker 160 connects the bidirectional inverter 140 to the electric power system 170. For example, the system linker 160 may adjust the range of voltage variations and suppress harmonic frequencies. The system linker 160 may also provide AC power to the electric power system 170, where a DC component has been removed from the AC power. The system linker 160 may also provide AC power from the electric power system 170 to the bidirectional inverter 140.

The electric power system 170 may be an electric company or an AC power system provided by an electricity generating company. For example, the electric power system 170 may include power plants, substations, and transmission lines electrically interconnected over a wide area. The electric power system 170 is commonly referred to as a “grid.”

The battery 180 may be a secondary battery capable of being charged and discharged. The battery 180 may be, for example, a lithium-ion (Li-ion) battery, a lithium polymer (Li-poly) battery or equivalents thereof, but the type of battery is not limited.

The BMS 190 maintains and manages the battery 180 to be in an optimal state. For example, the BMS 190 monitors the voltage, current and temperature of the battery 180 and warns a user upon detection of a failure. Further, the BMS 190 calculates the State of Charge (SOC) and State of Health (SOH) of the battery 180, performs cell balancing to equalize voltages or capacities of battery cells of the battery 180, and controls a cooling fan (not shown) to prevent overheating of the battery 180.

The bidirectional converter 200 converts DC power from the DC link 130 to a voltage level suitable for the battery 180. In addition, the bidirectional converter 200 converts DC power from the battery 180 to a voltage level suitable for the DC link 130. The bidirectional converter 200 may have a unitary structure. In addition, the bidirectional converter 200 may be an insulation-type or a non-insulation type.

The integrated controller 210 monitors and controls the MPPT converter 120, the bidirectional inverter 140, the system linker 160, the bidirectional converter 200. The integrated controller 210 also communicates with the battery monitoring system 190 to monitor the battery monitoring system 190. The integrated controller 210 controls the MPPT converter 120, the bidirectional inverter 140, the system linker 160, and the bidirectional converter 200 by sensing their voltages, currents, and temperatures. Further, the integrated controller 210 controls an interceptor 155 located between the load 150 and the system linker 160 to conditionally cut off the connection, for example, in the event of an emergency.

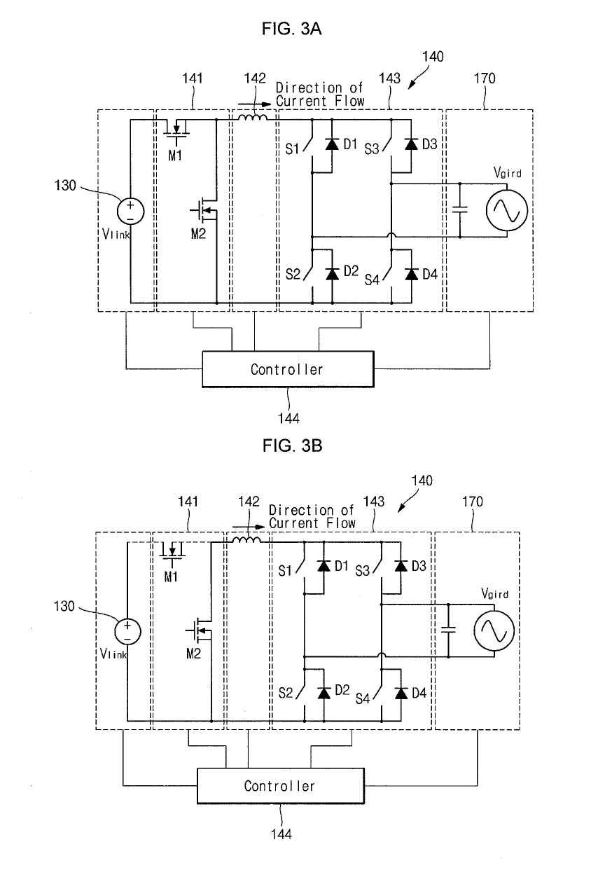

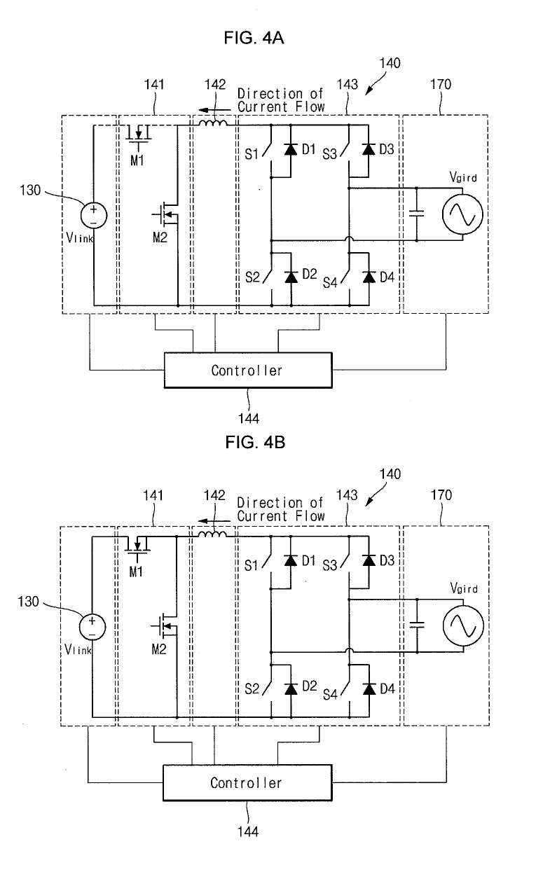

FIG. 2 is a block diagram of an embodiment of a bidirectional inverter for use in renewable energy storage system 100. FIG. 3A is a schematic diagram illustrating a mode 0 path when the bidirectional inverter of FIG. 2 operates in an inverter mode, FIG. 3B is a schematic diagram illustrating a mode 1 path when the bidirectional inverter of FIG. 2 operates in an inverter mode, FIG. 4A is a schematic diagram illustrating a mode 0 path when the bidirectional inverter of FIG. 2 operates in a PFC mode, and FIG. 4B is a schematic diagram illustrating a mode 1 path when the bidirectional inverter of FIG. 2 operates in a PFC mode.

As shown in FIG. 2, the bidirectional inverter 140 includes a switching unit 141, an inductor 142, a full-bridge switching unit 143, and a controller 144. As shown in FIG. 1, the bidirectional inverter 140 converts DC power from DC link 130 to AC power for load 150 or electric power system 170. This mode is called an inverter mode. In addition, the bidirectional inverter 140 may also convert AC power from the electric power system 170 to DC power for the DC link 130. This mode is also called a PFC mode.

The switching unit 141 is electrically connected between the DC link 130 and the electric power system 170. The switching unit 141 includes a first switch M1 and a second switch M2. When the bidirectional inverter 140 operates in an inverter mode, the switching unit 141 repeats a mode 0 and a mode 1 according to the on/off time ratio (or duty cycle) of the first switch M1. In addition, when the bidirectional inverter 140 operates in a PFC mode, the switching unit 141 repeats a mode 0 and a mode 1 according to the on/off time ratio of the second switch M2.

The first switch M1 is connected to the DC link 130 in series. Referring to FIGS. 3A and 3B, when the bidirectional inverter 140 operates in the inverter mode, the first switch M1 is turned on in the mode 0 and is turned off in the mode 1. Referring to FIGS. 4A and 4B, when the bidirectional inverter 140 operates in the PFC mode, the first switch M1 is turned off in the mode 0 and is turned on in the mode 1. The first switch M1 may be at least one selected from an N-channel field effect transistor (FET), an insulated gate bipolar transistor (IGBT), NPN type bipolar transistor, and equivalents thereof, but aspects of the invention are not limited thereto.

The second switch M2 is connected to the DC link 130 in parallel. Referring to FIGS. 3A and 3B, when the bidirectional inverter 140 operates in the inverter mode, the second switch M2 is turned off in the mode 0 and is turned on in the mode 1. In addition, referring to FIGS. 4A and 4B, when the bidirectional inverter 140 operates in the PFC mode, the second switch M2 is turned on in the mode 0 and is turned off in the mode 1. The second switch M2 may be at least one selected from an N-channel field effect transistor (FET), an insulated gate bipolar transistor (IGBT), NPN type bipolar transistor, and equivalents thereof, but aspects of the invention are not limited thereto.

Accordingly, the first switch M1 and the second switch M2 with opposite phase.

For example, when the bidirectional inverter 140 operates in the inverter mode, the switching unit 141 controls an on/off time ratio of the first switch M1 to control a current, and operates the second switch M2 to be on when the first switch is off and to be off when the first switch is on. In addition, for example, when the bidirectional inverter 140 operates in the PFC mode, the switching unit 141 controls the on/off time ratio of the second switch M2 to control a current, and operates the first switch M1 to be on when the second switch is off and to be off when the second switch is on.

As described above, since the switching unit 141 includes the first switch M1 and the second switch M2, switching loss of the bidirectional inverter 140 can be reduced.

The inductor 142 is electrically connected between the switching unit 141 and the full-bridge switching unit 143. The inductor 142 has a first electrode and a second electrode. The first electrode is connected between the first switch M1 and the second switch M2 of the switching unit 141, and the second electrode is connected to a first bridge switch S1 of the full-bridge switching unit 143. The inductor 142 stores energy between the switching unit 141 and the full-bridge switching unit 143 to boost or drop a voltage of the DC link 130.

The full-bridge switching unit 143 is electrically connected between the switching unit 141 and the electric power system 170. The full-bridge switching unit 143 includes a first bridge switch S1, a second bridge switch S2, a third bridge switch S3, and a fourth bridge switch S4. In addition, a diode is connected to each of the bridge switches S1, S2, S3, and S4 in parallel. Diodes connected to the first bridge switch S1, the second bridge switch S2, the third bridge switch S3, and the fourth bridge switch S4 are referred to as first, second, third and fourth diodes D1, D2, D3, and D4, respectively. The respective diodes D1, D2, D3, and D4 prevent currents from flowing one direction when the corresponding switch is open.

Here, the four bridge switches S1, S2, S3, and S4 of the full-bridge switching unit 143 operate in pairs. That is to say, the first bridge switch S1 and the fourth bridge switch S4 operate as one pair, and the second bridge switch S2 and the third bridge switch S3 operate as another pair. In addition, the first bridge switch S1 and the fourth bridge switch S4 operate in opposite phase as the second bridge switch S2 and the third bridge switch S3. The full-bridge switching unit 143 operates, for example, at about 60 Hz with a fixed on/off time ratio of about 50%. That is to say, the first bridge switch S1 and fourth bridge switch S4, and the second bridge switch S2 and the third bridge switch S3 repeatedly perform on/off operations at substantially constant time intervals.

The full-bridge switching unit 143 determines the polarity of a voltage applied to the electric power system 170. That is to say, if the first bridge switch S1 and the fourth bridge switch S4 are turned on, the voltage applied to the electric power system 170 is negative (−), and if the second bridge switch S2 and the third bridge switch S3 are turned on, the voltage applied to the electric power system 170 is positive (+). Therefore, the full-bridge switching unit 143 allows an AC power of about 220V to be supplied to the electric power system 170 when the DC link 130 provides power at about 110V.

The controller 144 is electrically connected to the DC link 130, the switching unit 141, the inductor 142, the full-bridge switching unit 143, and the electric power system 170. When the bidirectional inverter 140 operates in the inverter mode, for example, the controller 144 controls the on/off time ratio of the first switch M1 of the switching unit 141, so that the voltage at the DC link 130 to be kept at a substantially constant level. In addition, when the bidirectional inverter 140 operates in the PFC mode, for example, the controller 144 controls the on/off time ratio of the second switch M2 of the switching unit 141, so that the voltage applied to the DC link 130 is kept at a substantially constant level. The operation of the controller 144 will later be described in a greater detail.

The electric power system 170 is electrically connected to the full-bridge switching unit 143. The load, the interceptor switch, the system linker, etc. may be connected between the full-bridge switching unit 143 and the electric power system 170, which are, however, not illustrated in the drawing. In addition, a capacitor may further be connected to the electric power system 170, but practical embodiments are not limited thereto.

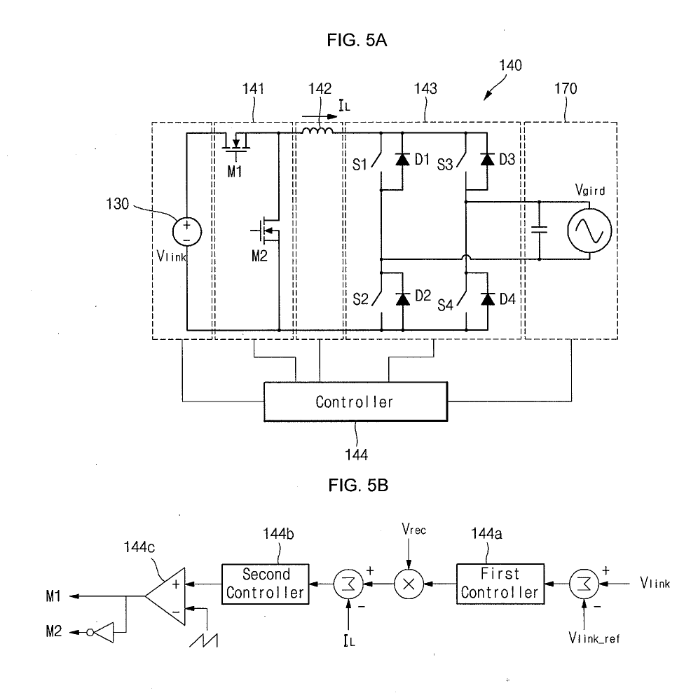

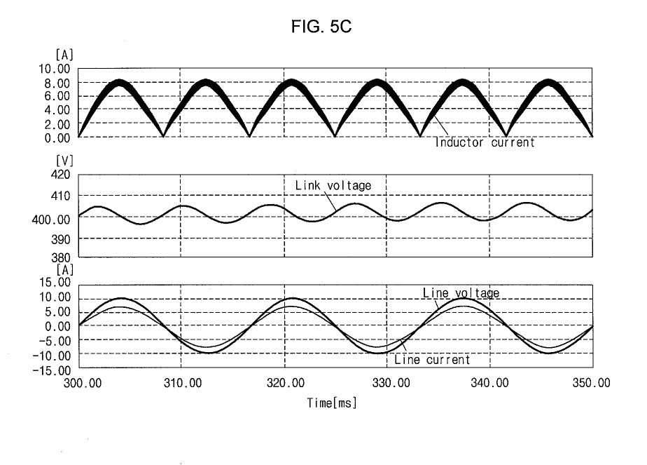

FIG. 5A is a block diagram of the bidirectional inverter of FIG. 2 operating in the inverter mode, FIG. 5B is a block diagram illustrating an algorithm of a controller in the bidirectional inverter operating in the inverter mode, and FIG. 5C is a graph illustrating waveforms of the bidirectional inverter operating in the inverter mode.

The bidirectional inverter 140 converts DC power of the DC link 130 to AC power and supplies the converted power to the electric power system 170. This mode is the inverter mode. Here, the DC link 130 may be fully charged by power from a solar cell or battery.

Referring to FIG. 5A and FIG. 5B, the controller 144 includes a first controller 144a, a second controller 144b, and a comparator 144c.

The first controller 144a controls a voltage of the bidirectional inverter 140. The first controller 144a measures a voltage Vₗᵢₙₖ of the DC link 130, compares the same with a reference voltage Vₗᵢₙₖ_{_{—}}_{ref}, and outputs a first output to cause the voltage Vₗᵢₙₖ of the DC link 130 to be substantially equal to the reference voltage Vₗᵢₙₖ_{_{—}}_{ref}. The reference voltage Vₗᵢₙₖ_{_{—}}_{ref} is stored in the first controller 144a. The first output is multiplied by a rectified signal V_{rec} of the voltage of the electric power system 170. A result of the multiplication of the first output by the rectified signal V_{rec} is a first current.

The second controller 144b compares the first current with a current I_{L} of the inductor 142 and outputs a second output to cause the first current to be substantially equal to the current I_{L} of the inductor 142. As shown, the current I_{L} of the inductor 142 flows in the direction from the DC link 130 to the electric power system 170.

The comparator 144c compares the second output with a sawtooth wave to generate a control signal CM1 to turn on the first switch M1 with a desired on/off time ratio. The comparator 144c also generates a control signal CM2 to turn on the second switch M2 with phase opposite the first switch M1.

If the second switch M2 is turned on, the voltage charged in the DC link 130 is supplied to the electric power system 170. The current of the inductor 142 increases, and energy is stored in the inductor 142. If the second switch M2 is turned off, the voltage charged in the DC link 130 is no longer supplied to the electric power system 170. Therefore, current is supplied to the electric power system 170 using the energy stored in the inductor 142. Therefore, the controller 144 adjusts current intensity with the control signal CM2 from the comparator 144c, which controls the on/off time ratios of the first and second switches M1 and M2. In addition, the comparator 144c turns the full bridge switching unit 143 on and off, so that the current is in phase with the electric power system 170.

FIG. 5C shows waveforms of a current of the inductor, a voltage of the DC link, a voltage of the electric power system, and a current of the electric power system.

As shown in FIG. 5C, the inductor 142 has current varying according to the state of the first switch M1 and the second switch M2. It is also shown that the current of the electric power system 170 is in phase with the voltage of the electric power system 170 and the current is supplied from the DC link 130 to the electric power system 170, thereby causing the voltage of the DC link 130 to be kept at a substantially constant level of about 400 V. The controller 144 controls the full-bridge switching unit 143 to be turned on and off through the second controller 144b to cause the current of the electric power system 170 to be in phase with the voltage of the electric power system 170.

As described above, the controller 144 controls on/off time ratios of the first switch M1 and the second switch M2, to cause the voltage at the DC link 130 to be kept at a substantially constant level.

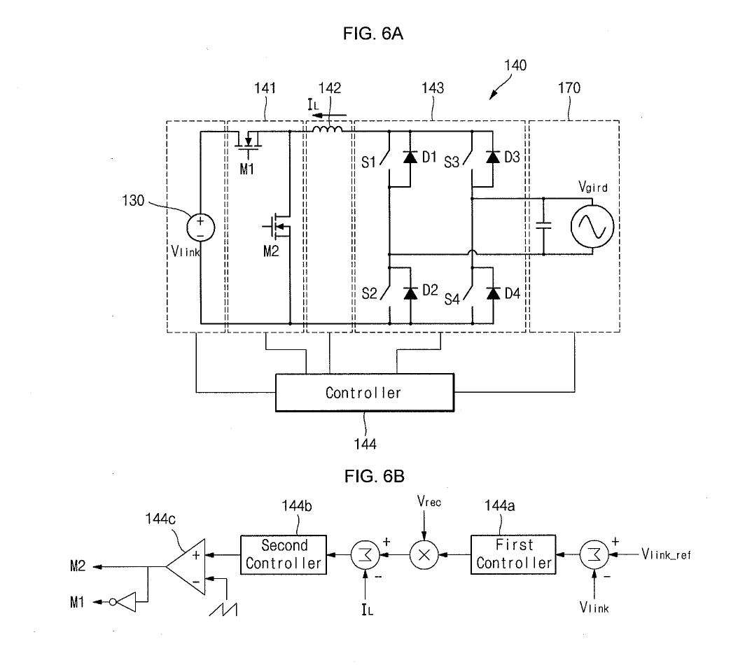

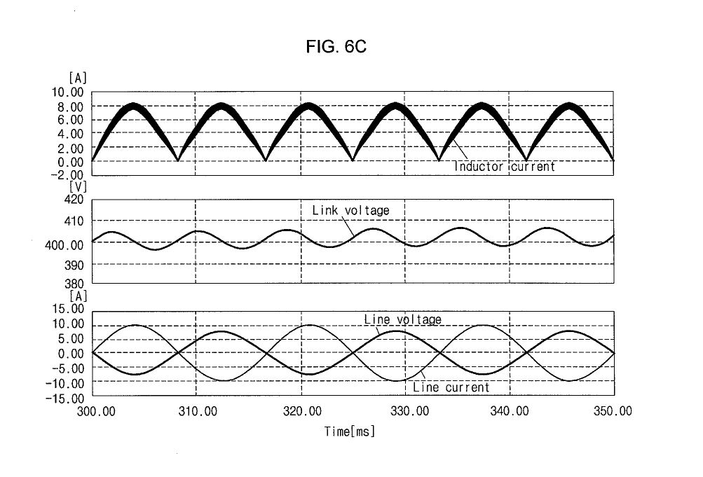

FIG. 6A is a block diagram of the bidirectional inverter operating in the PFC mode, FIG. 6B is a block diagram illustrating an algorithm of a controller in the bidirectional inverter operating in the PFC mode, and FIG. 6C is a graph illustrating waveforms of the bidirectional inverter operating in the PFC mode.

The bidirectional inverter 140 converts AC power of the electric power system 170 to DC power and supplies the converted power to the DC link 130. This mode is the PFC mode.

Referring to FIG. 6A and FIG. 6B, the controller 144 includes a first controller 144a, a second controller 144b, and a comparator 144c.

The first controller 144a measures a voltage Vₗᵢₙₖ of the DC link 130, compares the same with a reference voltage Vₗᵢₙₖ_{_{—}}_{ref}, and outputs a first output to cause the voltage Vₗᵢₙₖ of the DC link 130 to be substantially equal to the reference voltage Vₗᵢₙₖ_{_{—}}_{ref}. The reference voltage Vₗᵢₙₖ_{_{—}}_{ref} is stored in the first controller 144a. The first output is multiplied by a rectified signal V_{rec} of the voltage of the electric power system 170. A result of the multiplication of the first output by the rectified signal V_{rec} is a first current.

The second controller 144b compares the first current with a current I_{L} of the inductor 142 and outputs a second output to cause the first current to be substantially equal to the current I_{L} of the inductor 142. As shown, the current I_{L} of the inductor 142 flows in the direction from the electric power system 170 to the DC link 130.

The comparator 144c compares the second output with a sawtooth wave to generate a control signal CM2 to turn on the second switch M2 with a desired on/off time ratio. The comparator 144c also generates a control signal CM1 to turn on the first switch with phase opposite the second switch M2.

If the first switch M1 is turned on, the voltage charged in the electric power system 170 is supplied to the DC link 130. The current of the inductor 142 increases, and energy is stored in the inductor 142. If the first switch M1 is turned off, the voltage charged in the electric power system 170 is no longer supplied to the DC link 130. Therefore, the controller 144 adjusts current intensity with the control signal CM2 from the comparator 144c, which controls the on/off time ratios of the first and second switches M1 and M2. In addition, the comparator 144c turns the full-bridge switching unit 143 on and off, so that the current is out of phase from the electric power system 170.

FIG. 6C shows waveforms of a current of the inductor, a voltage of the DC link, a voltage of the electric power system, and a current of the electric power system.

As shown in FIG. 6C, the inductor 142 has current varying according to the state of the first switch M1 and the second switch M2. It is also shown that the current of the electric power system 170 is out of phase with the voltage of the electric power system 170 and the current is supplied from the electric power system 170 to the DC link 130, thereby causing the voltage of the DC link 130 to be kept at a substantially constant level.

As described above, the controller 144 controls on/off time ratios of the first switch M1 and the second switch M2, to cause the voltage at the DC link 130 to be kept at a substantially constant level.

Although various aspects have been described with reference to certain exemplary embodiments, it will be understood by those skilled in the art that a variety of modifications and variations may be made to the embodiments.

What is claimed is:

1. A bidirectional inverter of a renewable energy storage system configured to transmit power from a direct current (DC) link to an electric power system or to transmit power from the electric power system to the DC link, the bidirectional inverter comprising:
a switching unit including a first switch connected to the DC link in series and a second switch connected to the DC link in parallel;
an inductor electrically connected to the switching unit;
a full-bridge switching unit electrically connected to the inductor; and
a controller electrically connected to the switching unit and the full-bridge switching unit.

2. The bidirectional inverter of claim 1, wherein when the bidirectional inverter operates in an inverter mode, the controller controls an on/off time ratio of the first switch.

3. The bidirectional inverter of claim 1, wherein when the bidirectional inverter operates in an inverter mode, the controller controls an on/off time ratio of the second switch, wherein the on times of the second switch are of opposite phase as the on times of the first switch.

4. The bidirectional inverter of claim 1, wherein when the bidirectional inverter operates in a power factor correction (PFC) mode, the controller controls an on/off time ratio of the second switch.

5. The bidirectional inverter of claim 1, wherein when the bidirectional inverter operates in a PFC mode, the controller controls an on/off time ratio of the first switch, wherein the on times of the first switch are of opposite phase as the on times of the second switch.

6. The bidirectional inverter of claim 1, wherein when the bidirectional inverter operates in an inverter mode, the electric power system has a current in phase with a voltage thereof.

7. The bidirectional inverter of claim 1, wherein when the bidirectional inverter operates in a PFC mode, the electric power system has a current out of phase with a voltage thereof.

8. The bidirectional inverter of claim 1, wherein the controller comprises:
a first controller configured to control a voltage of the bidirectional inverter;
a second controller configured to control a current of the bidirectional inverter; and
a comparator configured to compare an output of the second controller with a sawtooth voltage signal and to generate controls signals for the switching unit to control on/off time ratios of the first switch and the second switch.

9. The bidirectional inverter of claim 1, wherein the first switch operates with phase opposite the phase of the second switch.

10. The bidirectional inverter of claim 1, wherein the full-bridge switching unit comprises:
a first bridge switch electrically connected to the inductor;
a second bridge switch electrically connected to the first bridge switch in series;
a third bridge switch electrically connected to the inductor; and
a fourth bridge switch electrically connected to the third bridge switch in series.

11. The bidirectional inverter of claim 10, wherein the first bridge switch and the fourth bridge switch are on substantially simultaneously, and the second bridge switch and the third bridge switch are on substantially simultaneously.

12. The bidirectional inverter of claim 10, wherein when the first bridge switch and the fourth bridge switch are turned on, the electric power system has a (−) voltage.

13. The bidirectional inverter of claim 10, wherein when the second bridge switch and the third bridge switch are turned on, the electric power system has a (+) voltage.

14. A renewable energy storage system connected to an electric power system, comprising:
a DC link; and
a bidirectional inverter configured to conditionally transmit power from the DC link to an electric power system and to conditionally transmit power from the electric power system to the DC link, the bidirectional inverter comprising:
a switching unit comprising a first switch connected to the DC link in series and a second switch connected to the DC link in parallel,
an inductor electrically connected to the switching unit,
a full-bridge switching unit electrically connected to the inductor, and
a controller electrically connected to the switching unit and the full-bridge switching unit.

15. The storage system of claim 14, wherein the controller is configured to modify an on/off time ratio of the first and second switches.

16. The storage system of claim 14, wherein the controller is configured to control the first and second switches so that when the first switch is on, the second switch is off, and when the second switch is on, the first switch is off.

17. The storage system of claim 14, wherein when the bidirectional inverter operates in an inverter mode, the electric power system has a current in phase with a voltage thereof.

18. The storage system of claim 14, wherein when the bidirectional inverter operates in a PFC mode, the electric power system has a current out of phase with a voltage thereof.

19. The storage system of claim 14, wherein the controller comprises:
a first controller configured to control a voltage of the bidirectional inverter;
a second controller configured to control a current of the bidirectional inverter; and
a comparator configured to compare an output of the second controller with a sawtooth voltage signal and to generate controls signals for the switching unit to control on/off time ratios of the first switch and the second switch.

20. The storage system of claim 14, wherein the full-bridge switching unit comprises:
a first bridge switch electrically connected to the inductor;
a second bridge switch electrically connected to the first bridge switch in series;
a third bridge switch electrically connected to the inductor; and
a fourth bridge switch electrically connected to the third bridge switch in series.
